(19) United States
(12) Patent Application Publication
(10) Pub. No.: US 2006/0153118 A1
(43) Pub. Date: Jul. 13, 2006

(54) SYSTEM AND METHOD FOR WIRELESS IP ADDRESS CAPACITY OPTIMIZATION

(75) Inventor: Todd C. Bailey, Fishkill, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 10/905,565

(22) Filed: Jan. 11, 2005

(51) Int. Cl. H04Q 7/00

(52) U.S. Cl. 370/328

(57) ABSTRACT

A system, method and program storage device for providing wireless connectivity to a user on a communications network including a plurality of users, each user having wireless connection capability and wired connection capability to a network server, including determining if a valid wired address is assigned to a first user; determining if a valid wireless address is assigned to the first user; responsive to the first user having both a valid wired address assigned and a valid wireless address assigned, the first user releasing one of the valid addresses for assignment to a second user. Requests from a user for first or second priority level address assignment are selectively granted by releasing and reassigning third or second priority level address assignments.

### FIELD OF THE INVENTION

This invention relates to the optimization of assignment of wireless connectivity.

### BACKGROUND OF THE INVENTION

Locations that use both wireless and wired intranet and/or Internet connectivity may suffer from wireless IP address capacity issues for those users that are connected to a hard-wire (Ethernet) connection, and also have a wireless network card. In these cases, the wired network card is assigned an IP address, while the wireless card is assigned a different IP address. Those users who use wired connections and are also assigned wireless IP addresses may limit the connectivity of wireless-only users, depending on the total number of wireless IP addresses available.

In some instances where the total number of potential wireless users exceeds the number of wireless IP addresses, some wireless users cannot obtain IP addresses until a logged user disconnects from the network (that is, the computer hibernates, reboots, and so forth.)

A solution to this problem is to purchase more wireless routers and assign more wireless IP addresses, but this can be cost and/or personnel intensive. A solution is needed that allows optimization of current wireless connectivity, potentially resulting in reduced wireless IP address capacity needs.

### SUMMARY OF THE INVENTION

A system, method and program storage device for providing wireless connectivity to a user on a communications network including a plurality of users, each user having wireless connection capability and optionally wired connection capability to a network server, including determining if a valid wired address is assigned to a first user; determining if a valid wireless address is assigned to the first user; responsive to the first user having both a valid wired address assigned and a valid wireless address assigned, the first user releasing one of the valid addresses for assignment to a second user.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a system diagram illustrating an exemplary embodiment of the invention.

FIG. 2 is a flow chart illustrating steps executed by a user computer to facilitate optimization of wireless connectivity.

FIG. 3 is a flow chart illustrating steps executed by a router to facilitate optimization of wireless connectivity.

FIG. 4 is a diagrammatic representation of a table, database, or equivalent collection of information used in the process of the invention for optimization of wireless connectivity.

FIG. 5 is a system diagram illustrating a program storage device for controlling the structure and operation of a computer according to the invention.

### DETAILED DESCRIPTION OF PREFERRED EMBODIMENTS

In accordance with an embodiment of the invention, the presence of a wireless IP address is detected in a user device which has wired connectivity, and the wireless IP address associated with the wired card is released. This action reduces the number of wireless IP addresses needed in a multi-user configuration by exactly the number of users connected to a wired connection.

Determining or estimating the number of users connected to a wired connection as compared with the total number of users (wired and wireless) dictates the necessary number of wireless IP addresses and allows optimization of wireless network routing hardware. This optimization may result in reduced need for wireless routers.

It may be possible, for those instances where connection continuity is essential, to “reserve” a wireless IP address on a wired computer. This IP address reservation carries a lower connection priority than that for a wireless-only user, but allows a wired user to disconnect from the network and not lose connectivity during a wireless address assignment delay.

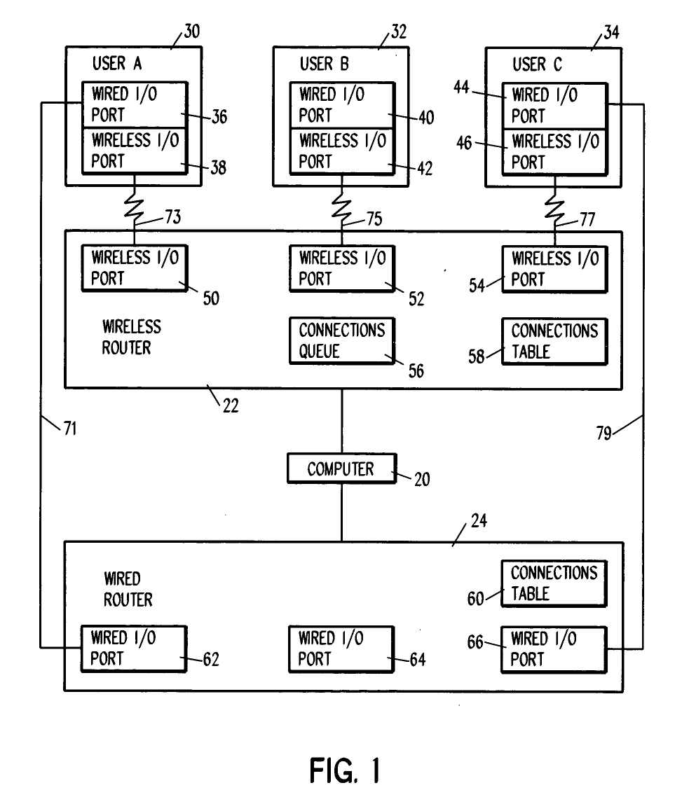

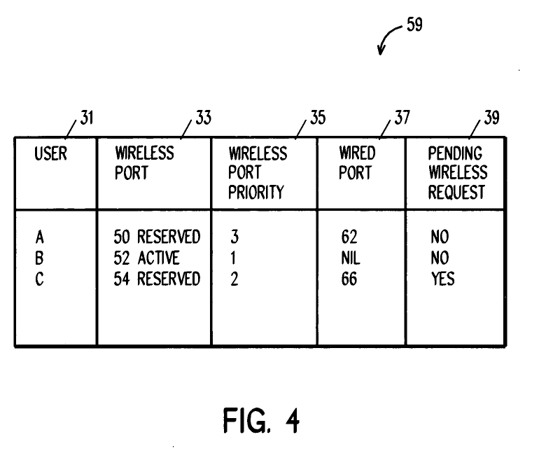

Referring to FIG. 1, user computers 30, 32, 34 are shown in various stages of connection with network server computer 20 through wireless router 22 and wired router 24. Computer 20 and routers 22 and 24 in combination comprise and may be referred to hereafter as a network server 20. The current state of these connections are summarized in the table of FIG. 4, as follows. Wired I/O port 36 of user 30 is connected over line 71 to wired I/O port 62 of router 24. Wireless I/O port 50 has been reserved, as is represented by line 73 to wireless I/O port 38, to user 30, but no request 39 for such a wireless connection 73 has been requested by user 30. Wired I/O port 42 of user 32 is in active connection through wireless I/O port 52 of router 22, as is represented by line 75. Wired I/O port 44 of user 34 is in active connection over line 79 with wired I/O port 66

of router 24, and responsive to a request 39 of user 34, wireless port 54 has been reserved to user 34 as is represented by line 77 and port 46. Wireless port priority levels are assigned to various connection scenarios as follows:

Priority 1: a wireless connection is active or has been requested by a user which does not have an active wired connection to router 24. Wireless address 52 assigned to user 32 is an example of a priority level 1 wireless address assignment.

Priority 2: a wireless connection is requested by a user which holds an active wired connection to router 24. Such a connection may be requested by a user in anticipation of terminating the wired connection and hoping to go wireless without losing connectivity to computer 20. Wireless address 54 assigned to user 34 is an example of a priority level 2 wireless address assignment.

Priority 3: a wireless connection is reserved to a user which holds an active wired connection to router 24 and has no pending request for a wireless connection. Wireless address 50 reserved or assigned to user 30 is an example of a priority level 3 wireless assignment.

In this embodiment, wireless router 22 maintains connections queue 56 and connections table 58, and wired router 24 maintains connections table 60. Tables 58 and 60 are represented by table 59 of FIG. 4, with table 58 including columns: user 31, wireless port 33, wireless port priority 35, and pending requests 39, and table 60 provides wired port 37 for users 31. Connections queue 56 provides a record of level 1 requests which have been received but not granted because there were, at the time of the request, no wireless port priority level 2 or 3 ports available for assignment.

Routers 22 and 24 may be combined in a single router if such accommodates both wired and wireless connections.

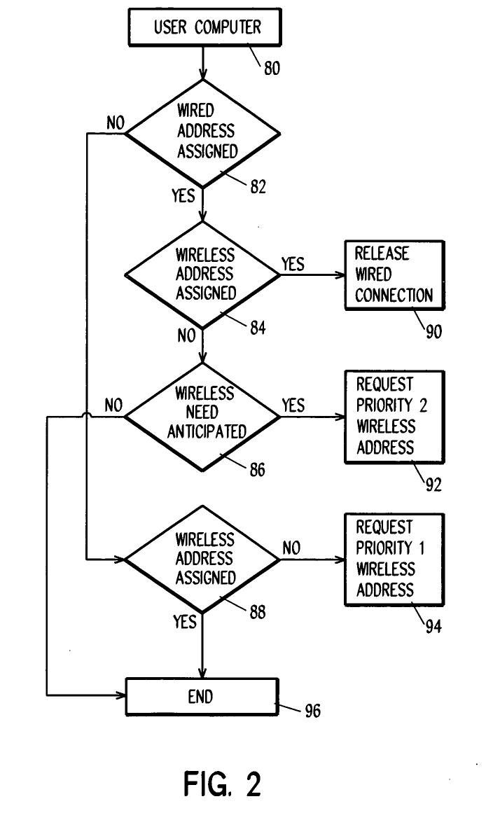

Referring to FIG. 2, a user computer 80 with at least one wireless connection capability (such as port 38 of user 30) and at least one wired connection capability (such as port 36 of user 30) executes the following process. In step 82, user 80 determines if a valid wired address is assigned to it. If so, and in step 84 it determines that it also has an active wireless connection, in step 90 user 80 releases its wired connection. If user 80 does not have a wired address assigned to it, in step 88 it determines if it has a wireless address. If so, processing ends at step 96, but if not, user 80 may, if it desires connectivity, request a priority level 1 wireless address assignment. In the event that user 80 has a wired address assigned and no wireless address assigned, user 80 may determine in step 86 that it intends to go to wireless operation and in step 92 request a priority level 2 wireless address in order to maintain connectivity to computer 20 when it drops its wired connection without experiencing an address assignment delay while wireless connectivity is established.

In this manner, user 80 on its own initiative operates to relinquish wireless addresses, making them available for assignment to other users.

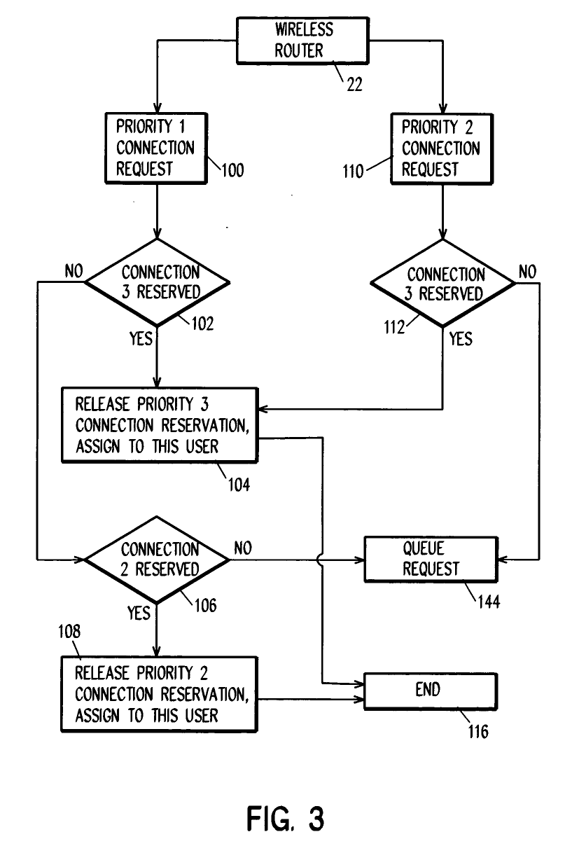

Referring to FIG. 3, wireless router 22 assigns wireless IP addresses according to the following process. In steps 100 and 110, router 22 awaits a connection request from a user.

In step 100, a priority level 1 connection request is received from a user which has no wired connection and desires to establish a wireless connection. Router 22 searches table 59 for a lowest priority level 35 wireless connection with which to satisfy request 100. In step 102, it determines if any priority level 3 wireless connections have been reserved. If one is found, in step 104 that priority level 3 connection reservation is released and the address assigned to this user. If no reserved priority level 3 wireless connection is found in table 59, in step 106 the table is searched for a wireless connection of priority level 2. If such is found, that connection is released and reassigned to this user as a priority 1 connection. If no level 2 connection is found, request 100 cannot be satisfied without taking a priority level 1 assignment. That is not generally done, and optionally in step 114 request 100 may be queued in connection queue 56. That queue may be periodically checked on a FIFO or LIFO or

some other basis as new priority level 2 or 3 connections are detected by router 22 or computer 20.

Responsive to a priority level 2 connection request 110, in step 112 router 22 determines if any priority level 3 wireless connections have been reserved. If one is found, in step 104 that priority level 3 connection reservation is released and the address assigned to this user. If not, request 110 may be queued in step 114 as previously described. Processing ends in step 116, which may include further processing to manage queue 56 as is described with respect to step 114.

In this manner, router 22 operates to grant or reserve wireless addressability or connectivity to requests from users by releasing and reassigning lowest available priority level connections.

Typically, some number (say, 256) of wired addresses and a separate number of wireless addresses are reserved by routers that have both wired and wireless capabilities. In this case, typically, wired connections cannot be released to provide wreless connectivity. In the case of static wired IP addresses, there is no benefit in releasing a wired

connection. However, in the case where wired IP addresses are assigned dynamically, a method for applying a similar test/optimization on the wired connection side may be executed where there is a shortage of wired connections.

While three levels of priority have been described, each of these levels may be further subdivided on additional considerations such as user ID or type. In general, requests for a higher priority level wireless or wired connection are satisfied by releasing and reassigning the lowest priority level connection available.

It is an advantage of the invention that there is provided a system and method for optimization of wireless connectivity.

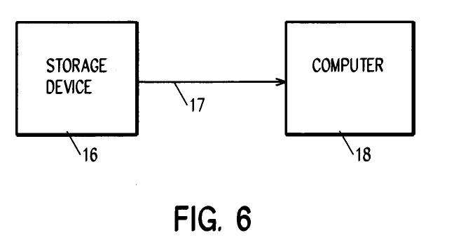

It will be appreciated that, although specific embodiments of the invention have been described herein for purposes of illustration, various modifications may be made without departing from the spirit and scope of the invention. Referring to FIG. 5, in particular, it is within the scope of the invention to provide a computer program product or program element, or a program storage or memory device such as a solid or fluid transmission medium

17, magnetic or optical wire, tape or disc 16, or the like, for storing signals readable by a machine, for controlling the operation of a computer 18 according to the method of the invention and/or to structure its components in accordance with the system of the invention.

Further, each step of the method may be executed on any general computer 18, such as IBM Systems designated as zSeries, iSeries, xSeries, and pSeries, or the like and pursuant to one or more, or a part of one or more, program elements, modules or objects generated from any programming language, such as C++, Java, PI/1, Fortran or the like. And still further, each said step, or a file or object or the like implementing each said step, may be executed by special purpose hardware or a circuit module designed for that purpose.

Accordingly, the scope of protection of this invention is limited only by the following claims and their equivalents.

What is claimed is:

1. A method for providing wireless connectivity to a user on a communications network including a plurality of users, each said user having wireless connection capability and optionally wired connection capability, to a network server, comprising the steps of:
determining if a valid wired address is assigned to a first user;
determining if a valid wireless address is assigned to said first user;
responsive to said first user having both a valid wired address assigned and a valid wireless address assigned, releasing one of said valid addresses for assignment to a second user.

2. The method of claim 1, further comprising the step of:
responsive to said first user having only a valid wired address assigned, selectively requesting assignment of a wireless address.

3. The method of claim 2, wherein
a first priority address assignment characterizes an address assigned to and selectively active on a wireless connection to a user which does not have an address assigned for a wired connection,
a second priority address assignment characterizes an address requested by and selectively assigned to but not active on a wireless connection to a user which has an address assigned for an active wired connection, and
a third priority address assignment characterizes an address for an inactive wireless connection to a user which has an active wired connection and no pending request for an address for a wireless connection, and further comprising the steps of
monitoring user connections for a request from a user for one of a first and a second priority wireless connection;
responsive to receiving a request for a first priority wireless connection, releasing and assigning to said user an address previously characterized as one of a second and a third priority address assignment; and
responsive to receiving a request for a second priority wireless connection, releasing and assigning to said user an address previously characterized as a third priority address assignment.

4. The method of claim 3, further comprising the steps of:
responsive to receiving a request for a first priority wireless connection when no second priority address assignment and no third priority address assignments is available, queuing said request for assignment of an address on condition of a wireless address assignment becoming available.

5. A system for providing wireless connectivity to a user on a communications network including a plurality of users, comprising:
a network server, each said user having wireless connection capability and, optionally, wired connection capability for connection to said network server;
said network server for selectively assigning a wired address to a first user;
said network server for selectively assigning a wireless address to said first user;
said first user operable for determining if a valid wireless address is assigned to said first user;
said first user further operable responsive to said first user having both a valid wired address assigned and a valid wireless address assigned for releasing one of said valid addresses for assignment to a second user.

6. The system of claim 5, further comprising:
a data store at said server for maintaining for each said user address indicia including assigned wireless
and assigned wired addresses, said assigned addresses characterized by priority levels.

7. The system of claim 6, wherein said priority levels include
a first priority level for an address assigned to and selectively active on a wireless connection to a user which does not have an address assigned for a wired connection,
a second priority level for an address requested by and selectively assigned to but not active on a wireless connection to a user which has an address assigned for an active wired connection, and
a third priority level for an address for an inactive wireless connection to a user which has an active wired connection and no pending request for an address for a wireless connection and wherein
said server is effective to monitor user connections for a request from a user for a first or second priority wireless connection,
responsive to receiving a request for a first priority wireless connection, said server is effective to release and assign to said user an address previously characterized as one of a second and a third priority address assignment; and
responsive to receiving a request for a second priority wireless connection, said server is effective to release and assign to said user an address previously characterized as a third priority address assignment.

8. A program storage device readable by a machine, tangibly embodying a program of instructions executable by a machine to perform a method for providing wireless connectivity to a user on a communications network including a plurality of users, each said user having wireless connection capability and wired connection capability to a network server, said method comprising the steps of:
determining if a valid wired address is assigned to a first user;
determining if a valid wireless address is assigned to said first user;
responsive to said first user having both a valid wired address assigned and a valid wireless address assigned, releasing one of said valid addresses for assignment to a second user.

9. The program storage device of claim 8, further comprising:
responsive to said first user having only a valid wired address assigned, selectively requesting assignment of a wireless address.

10. The program storage device of claim 9, wherein
a first priority address assignment characterizes an address assigned to and selectively active on a wireless connection to a user which does not have an address assigned for a wired connection, a second priority address assignment characterizes an address requested by and selectively assigned to but not active on a wireless connection to a user which has an address assigned for an active wired connection, and a third priority address assignment characterizes an address for an inactive wireless connection to a user which has an active wired connection and no pending request for an address for a wireless connection; and said method further comprises the steps of:
monitoring user connections for a request from a user for one of a first and a second priority wireless connection;
responsive to receiving a request for a first priority wireless connection, releasing and assigning to said user an address previously characterized as one of a second and a third priority address assignment; and
responsive to receiving a request for a second priority wireless connection, releasing and assigning to said user an address previously characterized as a third priority address assignment.

11. The program storage device of claim 10, said method further comprising the step of:
responsive to receiving a request for a first priority wireless connection when none of a second priority address and a third priority address assignment is available, queuing said request for assignment of an address on condition of a wireless address assignment becoming available.
